(19) United States
(12) Patent Application Publication
(10) Pub. No.: US 2006/0253355 A1
(43) Pub. Date: Nov. 9, 2006

(54) System and method for creating and trading a digital derivative investment instrument

(75) Inventor: Catherine T. Shalen, Chicago, IL (US)

Correspondence Address: BRINKS HOFER GILSON & LIONE, P.O. BOX 10395, CHICAGO, IL, 60610, US

(73) Assignee: Chicago Board Options Exchange

(21) Appl. No.: 11/122,659

(22) Filed: May 4, 2005

(51) Int. Cl. G06Q 40/00

(52) U.S. Cl. 705/35

(57) ABSTRACT

The present invention relates to an investment instrument which allows investors to take risk positions relative to the occurrence or non-occurrence of a contingent binary event. The contingent binary event will have one of two possible outcomes. In a digital futures contract, a long investor agrees to pay a short investor a contract futures amount in return for the short investor agreeing to pay the long investor one of two different settlement amounts depending on the outcome as the contingent binary event. Typically one settlement amount will be zero and the other will be an amount greater than the futures price.

### FIELD OF THE INVENTION

The present invention relates to methods of creating and trading derivative contracts whose value depends on the occurrence or non-occurrence of specified events.

### BACKGROUND OF THE INVENTION

Traditional futures contracts are well known investment instruments. A buyer purchases the right to receive delivery of an underlying commodity or asset on a specified date in the future. Conversely, a seller agrees to deliver the commodity or asset to an agreed location on the specified date. Futures contracts originally developed in the trade of agricultural commodities. Large consumers of agricultural products seeking to secure their future supply of raw ingredients like corn, wheat and other commodities would pay in advance for guaranteed delivery in the future. Producers in turn would sell in advance to raise capital to finance the cost of production. The success of agricultural futures soon led to futures activity surrounding other commodities as well. Today futures contracts are traded on everything from pork bellies to memory chips, and from stock shares to market indices.

Over the years futures contracts have evolved from simply a means of securing future delivery of a commodity into sophisticated investment instruments. Because futures contracts establish a price for the underlying commodity in advance of the date on which the commodity must be delivered, subsequent changes in the price of the underlying asset will inure to the benefit of one party and to the detriment of the other. If the price rises above the futures price, the seller is obligated to deliver the commodity at the lower agreed upon price. The buyer may then resell the received product at the higher market price to realize a profit. The seller in effect loses the difference between the futures contract price and the market price on the date the goods are delivered. Conversely if the price of the underlying commodity falls below the futures price, the seller can obtain the commodity at the lower market price for delivery to the buyer while retaining the higher futures price. In this case the seller realizes a profit in the amount of the difference between the current market price on the delivery date and the futures contract price. The buyer sees an equivalent loss.

As the preceding discussion makes clear, futures contracts lend themselves to speculating in price movements of the underlying commodity. Investors may be interested in taking a “long” position in a commodity, buying today at the present futures price for delivery in the future, in anticipation that prices for the commodity will rise prior to the delivery date. Conversely investors may wish to take a short position, agreeing to deliver the commodity on the delivery date at a price established today, in anticipation of falling prices.

As futures contracts have evolved away from merely a mechanism for securing future delivery of a commodity into sophisticated investment instruments, they have become more and more abstracted from the underlying assets on which they are based. Whereas futures contracts originally required actual delivery of the underlying commodity on the specified delivery date, today's futures contracts do not necessarily require assets to change hands. Instead, futures contracts may be settled in cash. Rather than delivering the underlying asset, cash settlement requires that the difference between the market price on the delivery date and the contract price be paid by one investor to the other, depending on which direction the market price has moved. If the prevailing market price is higher than the contract price, the investor who has taken a short position in the futures contract must pay the difference between the market price on the delivery date and the contract price to the long investor. Conversely, if the market price has fallen, the long investor must pay the difference between the contract price and the market price to the short investor in order to settle the contract.

Cash settlement allows further abstraction of futures contracts away from physical commodities or discrete units of an asset such as stock shares. Today futures contracts are traded on such abstract concepts as market indices and interest rates. Futures contracts on market indices are a prime example of the level of abstraction futures contracts have attained. Delivery of the underlying asset is impossible for a futures contract based on a market index such as the S&P 500. No such asset exists. However, cash settlement allows futures contracts to be written which allow investors to take positions relative to future movements in the value of an index, or other variable market indicators. A futures price is established based on a target value of the index on a specified “delivery” date. The difference between the target value price and the actual value of the index (often multiplied by a specified multiplier) is exchanged between the long and short investors in order to settle the contract. Traditionally, cash settlement occurs on the last day of trading for a particular contract. Thus, if the actual value of the index rises above the target value, the short investor must pay to the long investor an amount equal to the difference between the actual value and the target value times the specified multiplier. Conversely if the actual index value falls below the target value, the long investor must pay to the short investor the difference between the actual value and the target value multiplied by the multiplier.

The value of traditional futures contracts is inherently tied to the market price or value of the underlying asset and the agreed upon settlement price. The market value of the underlying asset itself, however, may be influenced by any number of external factors. For example, the amount of rainfall in Iowa in June could affect the value of corn futures for September delivery. The latest national productivity report may have a positive or negative impact on S&P 500 futures. If the share price of a particular company reaches a certain value, it may impact the price investors are willing to pay for futures based on that company's shares. The factors that influence the value of traditional futures contracts may also have an impact on other investments and assets. For example, if the share price of a market leader in a certain economic sector were to reach a certain value, it may signal to investors that the whole sector is poised for significant growth and may pull up the share price of other companies in the same sector. Likewise, an unexpected change in interest rates by the Federal Reserve may affect share prices broadly throughout the capital markets.

At present there is no mechanism whereby investors may take positions based on the occurrence or non-occurrence of various contingent events that may have broad impact across any number of individual investments. At best, investors may take a number of positions in various investments which the investor believes will all be effected in the same way by the occurrence or non-occurrence of a specific event. A problem with this approach is that the individual investments in which the investor takes a position may be influenced by factors other than the occurrence or non-occurrence of the specified event. Further, each individual investment may be affected differently by the occurrence or non-occurrence of the specified event. Thus, the investor can never fully isolate the economic impact that the occurrence or non-occurrence of a specified event may have, and directly invest in what he or she perceives to be the likely outcome of the event.

### SUMMARY

The present invention relates to methods for creating and trading digital derivative contracts. A digital futures contract is an investment instrument in which investors can take risk positions based on the probable occurrence or non-occurrence of an event. In exchange for receiving a futures price from the long investor, a short investor in a digital futures contract agrees to pay one of two specified settlement amounts to the long investor depending on the state of a binary variable at the expiration of the contract. Typically the settlement amounts will be $0 and some other value greater than the digital futures price. Thus, if the state of the binary variable is a first value, the short investor pays nothing to the long investor, and if the binary variable is a second value, the short investor pays the second amount less the futures price.

A method for creating such an instrument includes identifying a binary variable that must take on one of two different states on a specified date. Examples of such a variable include whether the value of a particular stock or market indicator has reached a predetermined threshold, whether a contingent event such as the Federal Reserve raising interest rates, or some other event has occurred or not occurred. A second step is to define a contract based on the identified variable. According to the contract a short investor agrees to pay to a long investor one of two different settlement amounts based on the state of the variable at the contract's expiration. The next step is to create a market for such a contract and accept bids and offers for both long and short positions in digital futures contracts. Digital futures contracts are executed by matching corresponding long and short positions. At expiration, the variable is evaluated and the contracts settled based on the state of the variable.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the appended claims.

### BRIEF DESCRIPTION OF THE DRAWINGS

FIG. 1 is a flow chart showing a method of creating a digital futures contract.

FIG. 2 is a sample listing of digital futures contracts.

FIG. 3 is a block diagram of a system for trading digital futures contracts.

FIG. 4 is a block diagram of exchange backend systems for supporting the trading of digital futures contracts.

### DETAILED DESCRIPTION OF THE PRESENTLY PREFERRED EMBODIMENTS

The present invention relates to a financial instrument in which investors may take positions on the contingent state of a binary variable at a specified time in the future, and a system for trading such instruments. In one embodiment, the financial instrument may be considered a “digital” futures contract in that it will settle at one of two different settlement amounts in the future based on the state of a binary variable at expiration. As with traditional futures contracts, a digital futures contract according to the present invention is merely a set of mutual promises between two parties—a first investor who desires to take a long position with regard to the eventual state of a particular binary variable and a second investor who desires to take a short position with regard to the eventual state of the binary variable. The long investor agrees to pay a certain amount, the futures price, to the short investor in exchange for the short investor agreeing to pay to the long investor one of the two different settlement amounts depending on the state of the binary variable when the contract is settled. Typically one of the two possible settlement values will be $0 and the other settlement value will be a non-zero value greater than the futures price.

Digital futures contracts are “digital” in that they may be created around virtually any question that will have only two possible answers: yes or no; true or false; 1 or 0; on or off; or the like. In general the digital futures contracts will be written around specific contingent events, events that may or may not occur. Typically the occurrence or non-occurrence of the specified event will be related to economic or market factors which investors may anticipate. For example a digital futures contract can be based on a binary variable that depends on whether the share price of a particular stock closes above a specified threshold on the expiration date of the contract. Conversely, a binary variable may depend on whether the share price closes below a specified threshold. Similarly, a binary variable can be established to determine whether a particular index or market indicator closes above or below a predefined threshold. Similar variables can be developed around economic indicators and interest rates. Alternatively, binary variables can be established based on whether a particular regulatory body takes a particular action or not. Will the federal reserve open market committee raise interest rates at its next meeting? Will the EPA bring an enforcement action against a particular company? Or the like. Specific examples of standard digital futures contracts may include for example, 30-year fixed mortgage rate digitals; Sweet Crude Oil Digitals; CBOE Volatility Index (VIX) digitals; Gold digitals. The potential list of digital futures contracts is essentially limitless.

Another “digital” quality of the digital futures contracts is the binary nature of the settlement amounts. Whereas traditional futures contracts have settlement amounts that directly reflect the value of the underlying asset in relation to the futures price, digital futures have only two possible settlement amounts, each corresponding to one state of the binary variable. For example, if the state of the binary variable turns out to be “no”, the second investor may be required to pay the first settlement amount to the first inventor. If the state of the binary variable turns out to be “yes” the second investor may be required to pay the second settlement amount to the first investor. In most cases one settlement amount will be zero and the other will be a substantial amount. Thus, the second investor will either pay the first investor nothing or a significant amount depending on the outcome of the binary variable. The first investor will be required to pay the futures price regardless. Thus, if the second investor is required to pay a non-zero amount, the futures price may be deducted from the settlement amount when the contract is settled.

Alternatively, a digital futures contract may be structured so that both the first investor and the second inventor deposit their maximum possible loss under the digital futures contract when the digital futures contract is formed. Then, as the binary variable turns out to be “no” or “yes,” the deposited amounts from the first or second investor shifts to the account of the investor holding the position corresponding to the result of the binary variable. For example, when a digital futures contract having a settlement value of $1,000 is formed, a first investor taking the long position deposits $400 and a second investor taking the short position deposits $600. At settlement after the binary variable turns out to be “no” or “yes,” one investor will have an account balance of $1,000 and the other investor will have an account balance of $0.

A hypothetical digital futures contract could be created around the binary question “Will the Dow Jones Industrial average close above 11,000 at the end of the second quarter of the present year?” Clearly, the answer to this question will be known on July 1, and it will be either yes or no. The investors entering into such a digital contract may agree on settlement amounts of $0 if the Dow closes at or below 11,000 and $100 if the Dow closes above 11,000. Further, the first investor may be willing to pay the second investor $70 for the right to receive either $0 or $100 depending on whether the Dow closes above 11,000 on July 1 or not. If on July 1 the Dow does not close above 11,000 the first investor pays the second investor $70 and the second investor owes the first investor nothing. Thus, the second investor, who took a short position in the contract, makes a $70 profit. The first investor, who took the long position, suffers a $70 loss. Contrarily, if the Dow does in fact close above $11,000 on July 1, the first investor is still obligated to pay the $70 futures price to the second investor, but now the second investor is obligated to pay the second settlement amount of $100. The $70 owed by the first investor may be deducted from the amount owed by the second investor. Thus, the second investor need actually pay only $30 to the first investor and the first investor need actually pay nothing. In this case the second investor suffers a $30 loss and the first investor sees a $30 gain. Thus in the present example, the first investor has placed $70 at risk with the opportunity to realize a $30 gain, whereas the second investor has placed $30 at risk with the opportunity to realize a $70 gain.

Of course in a real world scenario the amounts investors will be willing to risk on different positions will depend on how likely they perceive one result to be compared to the other. In the above example, for instance, if the stock market has been steadily rising and is approaching 11,000 investors may be less inclined to take the short position. This would tend to drive up the futures price in order to increase the possible return for the apparent increased risk that the Dow will in fact close above 11,000. Conversely, if the market has been stagnant and the Dow is nowhere near 11,000 it may be a good bet that it will not close above $11,000 by the end of the second quarter. Accordingly, investors may be less willing to take the long position thereby driving down the futures price.

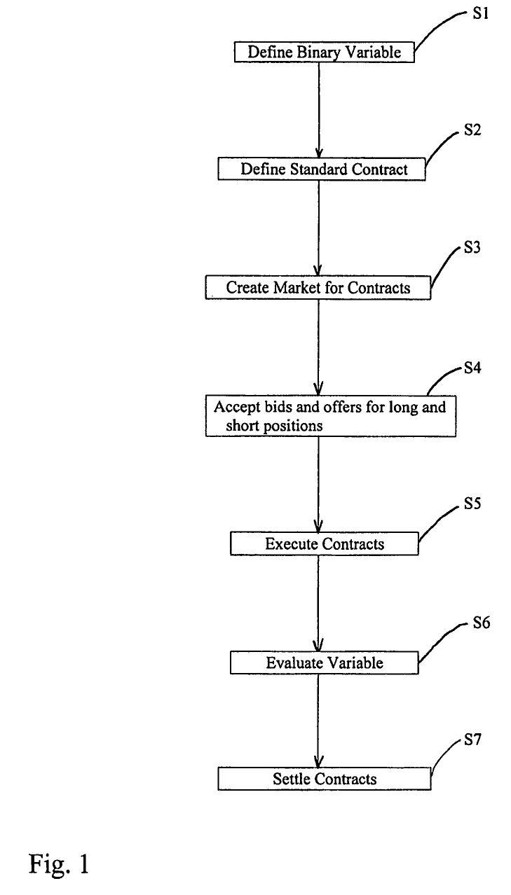

FIG. 1 shows a flow chart of a method of creating and trading a digital futures contracts according to the present invention. The first step S1 is to define a binary variable that may take on one of two different states at a time in the future (i.e. at expiration). The second step S2 is to define a standard digital futures contract. The standard contract will define the binary variable, establish both the first and second settlement amounts, and specify the expiration date of the contract. The futures price for the digital futures contracts based on the standard contract will be established in the open market. Step S3 is to create a market for the digital futures contracts. Step S4 is to accept bids, offers and purchase orders for both long and short positions in digital futures contracts which are to be created according to the standard digital futures contract. Step S5 is to execute digital futures contracts by matching corresponding orders for long and short positions. In step S6 the binary variable is evaluated at the expiration of the contract, and in step S7 the contract is settled.

It is intended that digital futures contracts according to the present invention will be traded on an exchange. The exchange may be a traditional open outcry exchange, or it may be an electronic trading platform such as the Chicago Board Options Exchange (CBOE) Futures Network (CFN). Employing the method outlined in FIG. 1, the exchange may from time to time identify binary variables in which it believes investors will be interested in taking positions. For example, the exchange may determine that investors will be interested in taking positions relative to the movement of 30-year fixed mortgage rates relative to one or more threshold values, or the price of a commodity such as sweet crude oil prices or gold prices, again relative to one or more price thresholds. Alternatively, the exchange may determine that investors are interested in taking positions regarding the movements of a particular index such as the CBOE volatility index (VIX), relative to certain significant threshold values.

In cases where the binary variable relates to the price or value of an underlying asset, commodity or market indicator, the step of identifying the binary variable requires identifying the underlying asset commodity or market indicator as well as defining a threshold value. For example, a CBOE Sweet Crude Oil Digital futures contract may be based on the price of a barrel of West Texas intermediate crude oil for delivery in Cushing, Okla. as published by the Department of Energy (DOE) on the last day of each month. Thresholds values may be established at even intervals, e.g., $48, $50, etc., with a first threshold being established at an even interval closest to the last price published by the DOE for West Texas crude. If desired, additional thresholds may be established above and below this value, and may serve as the basis for additional series of digital futures contracts. For example, if the DOE published a price of $47.50, a first threshold may be defined as $48 and three additional threshold values may be established above this value at $50, $52, and $54 and three below at, $42, $44, and $46. A binary variable may then be defined for each threshold value. In this case, the binary variable for each threshold may be defined by the question: “Is the price of West Texas sweet crude published by the DOE at the end of a specified month greater than $42, $44, $46, $48, $50, $52, or $54?” Each of these binary variables may serve as the basis for a separate series of digital futures contracts.

Once the binary variable has been defined, the exchange defines a standard digital futures contract (step S2) based on the defined variable. The standard contract created by the exchange will define the terms of the actual individual contracts that investors will enter when placing orders to take positions in the digital futures contracts. All of the details of the instrument must be spelled out. The binary variable must be defined; the settlement amounts established; the length of the contract; the date, possibly even the time when the binary variable will be evaluated; when and where the contracts may be traded; pricing conventions; delivery; and so forth. Using the example of CBOE Sweet Crude Digital Futures, the underlying variable may be defined as described above with settlement amounts of, for example, $1000 or $0 depending on whether the DOE published month end price is at or above the specified threshold value or not. The trading platform may be, for example, the electronic trading platform CBOEdirect® which allows trading between the hours of 8:30 A.M.-3:15 P.M. Central Standard Time. Contract trading may be limited monthly contracts, i.e., digital futures contracts that settle at the end of each month. The standard contract may set pricing conventions such as the granularity of price increments. For example, the CBOE Sweet Crude Oil Digital Futures prices may be limited to multiples of $10, e.g., $400, $410, $420, and so forth, while the price of the underlying commodity, West Texas Sweet Crude, is stated to two decimal places, e.g., $48.25. A minimum tick size such as $10 may also be established. Further contingencies can be spelled out, such as what will the impact of the DOE revising its price after contracts have settled, or how contracts will be settled if the DOE fails to publish a price on the specified settlement date. Finally, delivery provisions may be spelled out. For example, the buyer may be required to deposit the entire futures price, and the seller the greater of the two settlement amounts less the futures price. The two accounts may then be marked-to-market on a daily basis based on changes in the futures price. However, the accounts may be set up such that investors may not withdraw their funds until the business day after the final settlement date to ensure that sufficient funds are available to cover the contract.

Step S3 from FIG. 1 may be accomplished by listing one or more defined contracts on an exchange or trading platform. Listing a contract includes disseminating information about the contract to potential investors and providing a mechanism whereby investors may make bids and offers and place orders for the contracts. The CBOE Sweet Crude or Digitals of the present example may be traded on the CBOEdirect electronic trading platform. CBOEdirect is a trading facility which disseminates information regarding contracts traded on the platform, and allows brokers and dealers to place orders for customers who enter bids and make offers to buy and sell positions in such contracts.

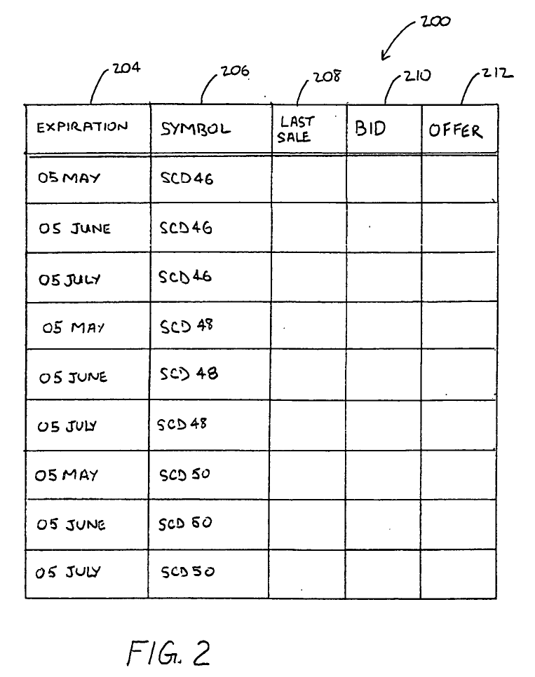

FIG. 2 is a sample listing 200 for CBOE Sweet Crude Oil Digitals. The listing 200 includes a plurality of different CBOE Sweet Crude Oil Digital futures contracts 202. Each contract includes a series expiration date 204, a trading symbol 206; a last sale price 208, a current bid 210, current offer 212. In the sample listing 200, the trading symbols SCD all refer to CBOE Sweet Crude Oil Digitals. The number following the symbol refers to the binary threshold for determining the settlement amount. The expiration 204 indicates the month at the end of which the contract will settle. The listing 200 includes three series of digital futures contracts based on a sweet crude oil price threshold of $46. One that settles at the end of May 2005, one that settles the end of June and one that settles the end of July. The listing 200 further includes Sweet Crude Oil Digital futures having May, June and July expirations and having price thresholds of $50.

Essentially, once a contract is defined and listed, the CBOEdirect electronic trading platform, in conjunction with other backend systems of the exchange, is responsible for all of the remaining steps of the method 100 shown in FIG. 1. CBOEdirect accepts bids and offers from investors or brokers (Step S4), and executes marketable orders by matching buyers to sellers (Step S5.) Other backend systems operated by the exchange evaluate the binary variables (Step S6) and settle the contracts at expiration (Step S7).

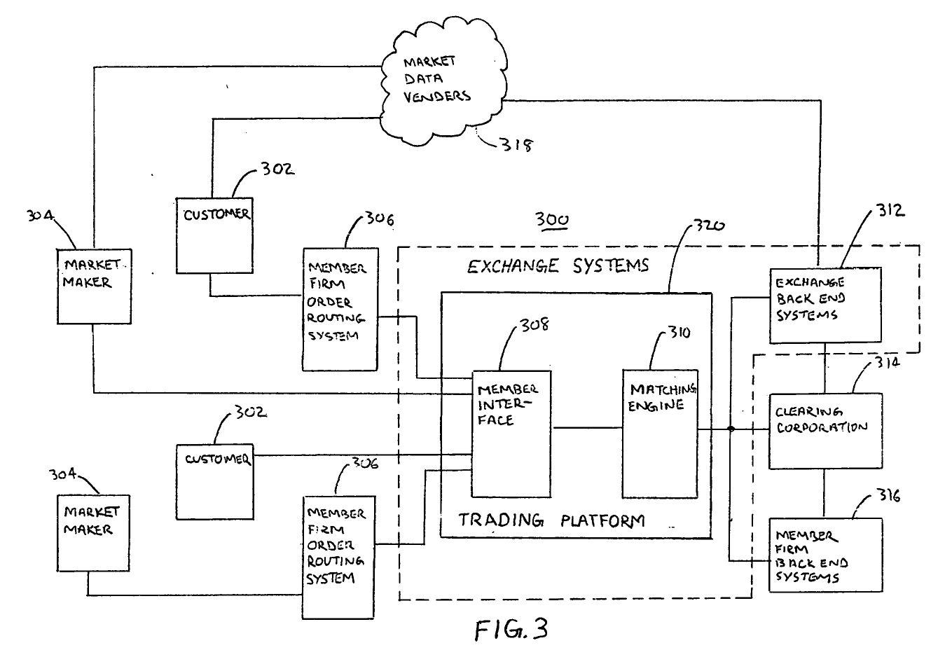

FIG. 3 shows an electronic trading system 300 which may be used for listing and trading digital futures contracts. The system 300 includes components operated by an exchange, as well as components operated by others who access the exchange to execute trades. The components shown within the dashed lines are those operated by the exchange. Components outside the dashed lines are operated by others, but nonetheless are necessary for the operation of a functioning exchange. The exchange components of the trading system 300 include an electronic trading platform 320, a member interface 308, a matching engine 310, and backend systems 312. Backend systems not operated by the exchange but which are integral to processing trades and settling contracts are the Clearing Corporation's systems 314, and Member Firms' backend systems 316.

Market Makers may access the trading platform 320 directly through personal input devices 304 which communicate with the member interface 308. Market makers may quote prices for digital futures contracts. Non-member Customers 302, however, must access the exchange through a Member Firm. Customer orders are routed through Member Firm routing systems 306. The Member Firms' routing systems 306 forward the orders to the exchange via the member interface 308. The member interface 308 manages all communications between the Member Firm routing systems 306 and Market Makers' personal input devices 304; determines whether orders may be processed by the trading platform; and determines the appropriate matching engine for processing the orders. Although only a single matching engine 310 is shown in FIG. 3, the trading platform 320 may include multiple matching engines. Different exchange traded products may be allocated to different matching engines for efficient execution of trades. When the member interface 302 receives an order from a Member Firm routing system 306, the member interface 308 determines the proper matching engine 310 for processing the order and forwards the order to the appropriate matching engine. The matching engine 310 executes trades by pairing corresponding marketable buy/sell orders. Non-marketable orders are placed in an electronic order book.

Once orders are executed, the matching engine 310 sends details of the executed transactions to the exchange backend systems 312, to the Clearing Corporation systems 314, and to the Member Firms' backend systems 316. The matching engine also updates the order book to reflect changes in the market based on the executed transactions. Orders that previously were not marketable may become marketable due to changes in the market. If so, the matching engine 310 executes these orders as well.

The exchange backend systems 312 perform a number of different functions. For example, contract definition and listing data originate with the Exchange backend systems 312. Pricing information for digital futures contracts is disseminated from the exchange backend systems to market data vendors 318. Customers 302, market makers 304, and others may access the market data regarding digital futures contracts via, for example, proprietary networks, on-line services, and the like. The exchange backend systems also evaluate the binary variable on which the digital futures contracts are based. At expiration, the backend systems 312 determine the appropriate settlement amounts and supply final settlement data to the Clearing Corporation. The Clearing Corporation acts as the exchange's bank and performs a final mark-to-market on Member Firm margin accounts based on the positions taken by the Member Firms' customers. The final mark-to-market reflects the final settlement amounts for the digital futures, and the Clearing Corporation debits/credits Member Firms' accounts accordingly. These data are also forwarded to the Member Firms' systems 316 so that they may update their customer accounts as well.

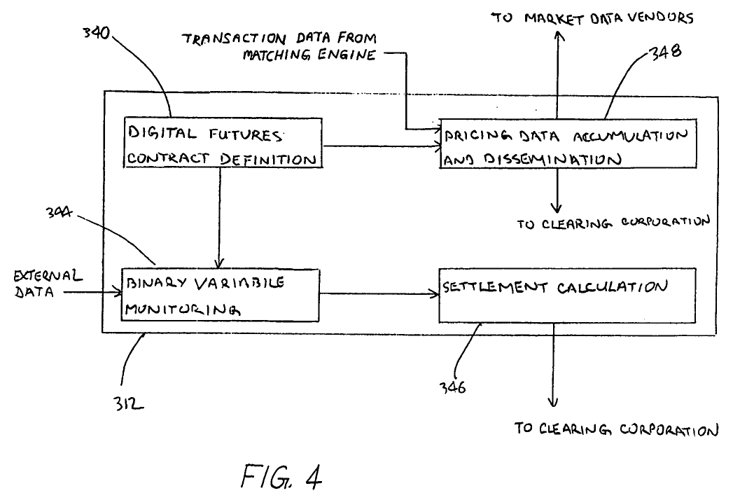

FIG. 4 shows the exchange backend systems 312 needed for trading digital futures in more detail. A digital futures contract definition module 340 stores all relevant data concerning the digital futures contract to be traded on the trading platform 320, including the contract symbol, the definition of the binary variable, the underlying asset (if there is one) the threshold value, or the event description, etc. A pricing data accumulation and dissemination module 348 receives contract information from the digital futures contract definition module 340 and transaction data from the matching engine 310. The pricing data accumulation and dissemination module 348 provides the market data regarding open bids and offers and recent transactions to the market data vendors 318. The pricing data accumulation and dissemination module 348 also forwards transaction data to the Clearing Corporation so that the Clearing Corporation may mark-to-market the accounts of Member Firms at the close of each trading day, taking into account current market prices for the digital futures contracts. Finally, a settlement calculation module 346 receives input from the binary variable monitoring module 344. On the settlement date the settlement calculation module 346 calculates the settlement amount based on the state of the binary variable. The settlement calculation module 346 forwards the settlement amount to the Clearing Corporation which performs a final mark-to-market on the Member Firms' accounts to settle the digital futures contract.

The method of creating and trading digital futures contracts and the system for trading such contracts provides investors with a vehicle where they may isolate a single binary event and take a position relative to their estimate of whether the event will occur or will not occur. Thus, investors will be able to take positions relative to the events themselves rather taking indirect positions in the expected effects the occurrence or non-occurrence of the event will cause. The ability to take positions regarding such binary events allows investors to more accurately and efficiently manage risk.

A digital derivative contract may also be structured as a digital option contract and trade on an exchange as described above for a digital futures contract. Typically, a digital option contract is structured so that the option pays out a specified amount if the option expires in-the-money, or pays out nothing if the option expires out-of-the-money.

In one embodiment, the digital option contract is a digital put option contract based on an underlying asset or economic indicator with a strike price based on the current price of the underlying asset. At expiration of the digital put option contract, the option pays out a specified amount if the strike price is greater than or equal to the value of the underlying asset at expiration of the digital put option contract. However, if the strike price is less than the value of the underlying asset at expiration of the digital put option contract, the option pays out nothing.

In another embodiment, the digital option contract is a digital call option contract based on an underlying asset with a strike price based on the current price of the underlying asset. At expiration of the digital call option contract, the option pays out a specified amount if the strike price is less than or equal to the value of the underlying asset at expiration of the digital call option contract. However, if the strike price is greater than the value of the underlying asset at expiration of the digital call option contract, the option pays out nothing.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method of creating a financial instrument comprising:
identifying a variable that will assume one of a first state and a second state at a designated time;
establishing a contract between a first investor and a second investor in which the first investor agrees to pay a futures price to the second investor and the second investor agrees to pay to the first investor one of a first settlement amount and a second settlement amount, depending on whether the variable has assumed the first state or the second state;
determining which of the first state and the second state the variable has assumed at the designated time; and
settling the contract according to the state assumed by the variable.

2. The method of claim 1 wherein the step of settling the contract comprises the first investor paying the futures price to the second investor and the second investor paying the first settlement amount to the first investor if the variable has assumed the first state, and the second settlement amount if the variable has assumed the second state.

3. The method of claim 1 wherein the first settlement amount is zero and the second settlement amount is a non-zero value greater than the futures price.

4. The method of claim 3 wherein the step of settling the contract corresponds to the first investor paying the futures price to the second investor when the variable assumes the first state at the designated time.

5. The method of claim 3 wherein the step of settling the contract comprises the second investor paying the first investor the second settlement less the futures price.

6. The method of claim 1 wherein the variable relates to the occurrence of a defined contingent event, the first state corresponding to the non-occurrence of the event as of the designated time and the second state corresponding to the occurrence of the event as of the designated time.

7. The method of claim 6 wherein the contingent event comprises a second variable having achieved a predefined value.

8. The method of claim 7 wherein the second variable comprises a market index.

9. The method of claim 7 wherein the second variable comprises the price of an underlying asset.

10. The method of claim 7 wherein the second variable comprises the value of an economic indicator.

11. The method of claim 6 wherein the contingent event comprises a specified action of an organization.

12. A method of trading digital futures contracts comprising defining a standard digital futures contract having one of a first settlement amount and a second settlement amount, contingent on the state of a digital variable on a specified date;
accepting long positions and short positions and matching at least one long investor with at least one short investor to form at least one digital futures contract based on said standard digital futures contract;
determining the state of the digital variable on the specified date; and
settling the at least one digital futures contract.

13. The method of claim 12 wherein an investor taking a long position agrees to pay a futures price in return for the obligation of a short investor to pay one of the first and second settlement amounts depending on the state of the digital variable on the specified date.

14. The method of claim 13 wherein the first settlement amount is zero.

15. The method of claim 13 wherein the second settlement amount is an amount greater than the futures price.

16. The method of claim 12 wherein the digital variable takes on a first state if a specified event occurs and a second state if the specified event does not occur.

17. The method of claim 16 wherein the specified event comprises a numeric variable rising above a threshold value.

18. A method of investing in the occurrence or non-occurrence of a contingent event, comprising:
a first investor agreeing with a second investor to pay a futures price to the second investor in exchange for the second investor agreeing to pay one of a first amount and a second amount depending on whether the contingent event occurs or does not occur;
determining whether the event occurs or does not occur;
the first investor settling with the second investor based on the determination whether the event occurred or did not occur.

19. The method of claim 18 wherein the contingent event comprises a share price rising above a threshold.

20. The method of claim 18 wherein the contingent event comprises a share price falling below a threshold.

21. The method of claim 18 wherein the contingent event comprises a market indicator rising above threshold.

22. The method of claim 18 wherein the contingent event comprises a market indicator falling below a threshold.

23. The method of claim 18 wherein the contingent event comprises a regulatory body taking a specified action.

24. The method of claim 18 wherein the contingent event comprises an interest rate rising above a threshold.

25. The method of claim 18 wherein the contingent event comprises an interest rate falling below a threshold.

26. The method of claim 18 wherein the contingent event comprises an economic indicator rising above a threshold.

27. The method of claim 18 wherein the contingent event comprises an economic indicator falling below a threshold.

28. The method of claim 18 wherein the first amount agreed to be paid by the second investor to the first investor depending on whether the contingent event occurs or not is zero and the second amount is an amount greater than the futures prices.

29. The method of claim 28 wherein the first investor settling with the second investor comprises the first investor paying the second investor the futures price if the contingent event does not occur, and the second investor paying the first investor the second amount less the futures price if the contingent event does occur.

30. A system for creating a digital futures contract to be traded on an exchange, the system comprising:
a contract definition module for receiving user input and defining terms of a digital futures contract, including a binary variable and first and second settlement amounts, one of which is to be paid by a first party to a second party based on a state of the binary variable;
a pricing data accumulation and dissemination module for receiving price data based on executed trades of said digital futures contracts, and disseminating said pricing data to investors;
a binary variable monitoring module for determining the state of the binary variable; and
a settlement calculation model for calculating a settlement amount based on the state of the binary variable at expiration of the digital futures contract.

31. A method of creating a financial instrument comprising:
identifying an underling asset for a digital option contract;
establishing the digital option contract in which an investor will receive one of a first settlement amount and a second settlement depending on whether a strike price of the digital option contract is less than, equal to, or greater than the value of the underlying asset at expiration of the digital option contract;
determining whether the strike price of the digital option contract is less than, equal to, or greater than the value of the underlying asset at expiration of the digital option contract; and
settling the contract according to whether the strike price of the digital option contract is less than, equal to, or greater than the value of the underlying asset at expiration of the digital option contract.

32. The method of claim 31, wherein:
the digital option contract is a digital call option contract;
the investor receives the first settlement amount if the strike price of the digital call option contract is less than or equal to the value of the underlying asset at expiration of the digital call option contract; and
the investor receives the second settlement amount if the strike price of the digital call option contract is greater than the value of the underlying asset at expiration of the digital call option contract.

33. The method of claim 32, wherein the first settlement amount is a non-zero value and the second settlement amount is zero.

34. The method of claim 31, wherein:
the digital option contract is a digital put option contract;
the investor receives the first settlement amount if the strike price of the digital call option contract is greater than or equal to the value of the underlying asset at expiration of the digital put option contract; and
the investor receives the second settlement amount if the strike price of the digital call option contract is less than the value of the underlying asset at expiration of the digital put option contract.

35. The method of claim 34, wherein the first settlement amount is a non-zero value and the second settlement amount is zero.

36. The method of claim 31, wherein the underlying asset is an economic indicator.

37. A system for creating a digital option contract to be traded on an exchange, the system comprising:
a contract definition module for receiving user input and defining terms of a digital option contract, including an underlying asset, a strike price, and first and second settlement amounts, the first and second settlement amounts paid to an investor depending on whether the strike price is less than, equal to, or greater than the value of the underlying asset at expiration of the digital option contract;
a pricing data accumulation and dissemination module for receiving price data based on executed trades of said digital options contracts, and disseminating said pricing data to investors;
a binary variable monitoring module for determining the state of the strike price in relation to the value of the underlying asset; and
a settlement calculation model for calculating a settlement amount based on the state of the strike price in relation to the value of the underlying asset at expiration of the digital option contract.

38. The system of claim 37, wherein:
the digital option contract is a digital call option contract;
the investor receives the first settlement amount if the strike price of the digital call option contract is less than or equal to the value of the underlying asset at expiration of the digital call option contract; and
the investor receives the second settlement amount if the strike price of the digital call option contract is greater than the value of the underlying asset at expiration of the digital call option contract.

39. The system of claim 38, wherein the first settlement amount is a non-zero value and the second settlement amount is zero.

40. The system of claim 37, wherein:
the digital option contract is a digital put option contract;
the investor receives the first settlement amount if the strike price of the digital call option contract is greater than or equal to the value of the underlying asset at expiration of the digital put option contract; and
the investor receives the second settlement amount if the strike price of the digital call option contract is less than the value of the underlying asset at expiration of the digital put option contract.

41. The system of claim 40, wherein the first settlement amount is a non-zero value and the second settlement amount is zero.

42. The system of claim 37, wherein the underlying asset is an economic indicator.
